(19) United States
(12) Patent Application Publication
(10) Pub. No.: US 2021/0229677 A1
(43) Pub. Date: Jul. 29, 2021

(54) DISTURBANCE DEGREE CALCULATION SYSTEM AND DRIVING GUIDE SYSTEM

(71) Applicant: DENSO CORPORATION, Kariya-city (JP)

(72) Inventors: Takaaki SUGIYAMA, Kariya-city (JP); Masahiko KAWAMOTO, Kariya-city (JP); Yoshinori KAWABATA, Kariya-city (JP); Toshihiro SHINTAI, Kariya-city (JP); Akemi KOGA, Kariya-city (JP); Masaru SAWAKI, Kariya-city (JP)

(21) Appl. No.: 17/231,643

(22) Filed: Apr. 15, 2021

Related U.S. Application Data
(63) Continuation of application No. PCT/JP2019/035339, filed on Sep. 9, 2019.

(30) Foreign Application Priority Data
Oct. 19, 2018 (JP) 2018-197525
Oct. 19, 2018 (JP) 2018-197526

(51) Int. Cl. B60W 40/09; B60W 40/02; G06K 9/00; B60W 30/08; G06K 9/62; G06N 20/00

(52) U.S. Cl. CPC B60W 40/09; B60W 40/02; G06K 9/00845; B60W 2420/52; G06K 9/6267; G06N 20/00; B60W 2540/30; B60W 30/08

(57) ABSTRACT

A disturbance degree calculation system includes a sensor that acquires data on a factor that hinders safe driving of a driver, and a disturbance degree calculation unit that calculates a disturbance degree indicating a degree of disturbance to the driver's safe driving based on the factor hindering the safe driving of the driver.

### CROSS REFERENCE TO RELATED APPLICATIONS

This application is a continuation application of PCT/JP2019/035339 filed on Sep. 9, 2019, which designated the U.S and claims the benefit of priority from Japanese Patent Application No. 2018-197525 filed on Oct. 19, 2018 and Japanese Patent Application No. 2018-197526 filed on Oct. 19, 2018. The entire disclosures of all of the above applications are incorporated herein by reference.

### TECHNICAL FIELD

The present disclosure relates to a disturbance degree calculation system and a driving guide system.

### BACKGROUND

There is a proposed system that detects an abnormality in driving ability of a driver due to drowsiness, drunkenness, or other causes, and issues a warning in case of the abnormality.

### SUMMARY

The present disclosure provides a disturbance degree calculation system. An example of the disturbance degree calculation system comprises a sensor that acquires data on a factor that hinders safe driving of a driver. The disturbance degree calculation system calculates a disturbance degree indicating a degree of disturbance to the driver's safe driving based on the factor hindering the safe driving of the driver.

The present disclosure also provides a driving guide system. An example of a driving guide system comprises a sensor that acquires data on a factor that hinders safe driving of a driver. The driving guide system calculates a disturbance degree indicating a degree of disturbance to the driver's safe driving based on the factor hindering the safe driving of the driver. The driving guide system sets a threshold for level classification of the disturbance degree. Depending on the level, the driving guide system determines guide contents that improve vehicle safety. The driving guide system implements the determined guide contents.

### BRIEF DESCRIPTION OF THE DRAWINGS

Objects, features and advantages of the present disclosure will become more apparent from the below-described detailed description made with reference to the accompanying drawings. In the drawings:

FIG. 1 is a block diagram schematically illustrating a configuration of a driving guide system according to an embodiment;

FIG. 2 is a diagram schematically illustrating features;

FIG. 3 is a diagram schematically illustrating tuning of levels of disturbance degree;

FIG. 4 is a flowchart schematically illustrating a process for level determination of disturbance degree;

FIG. 5 is a diagram schematically illustrating levels of disturbance degree and guide contents;

FIG. 6 is a flowchart schematically illustrating processes in a driving guide system;

FIG. 7 is a diagram schematically illustrating an operation example;

FIG. 8 is a diagram schematically illustrating an operation example; and

FIG. 9 is a diagram schematically illustrating an operation example.

### DETAILED DESCRIPTION

A proposed system detects an abnormality in driving ability of a driver due to drowsiness, drunkenness, or other causes, and issues a warning in case of the abnormality. However, there may be a case where the driver is not unable to driver but the driving is disturbed. A system performing driving guide for the driver in cases including this does not exist.

An object of the present disclosure is to provide a disturbance degree calculation system that calculates a disturbance degree with respect to safe driving in a driver. Another object of the present disclosure is to provide a driving guide system that calculates a disturbance degree with respect to safe driving in a driver and performs guiding the driver or the like according to the disturbance degree.

In one aspect of the present disclosure, a disturbance degree calculation system comprises: a sensor that acquires data on a factor that hinders safe driving of a driver; and a disturbance degree calculation unit that calculates a disturbance degree indicating a degree of disturbance to the driver's safe driving based on the factor hindering the safe driving of the driver. With this configuration, it is possible to provide a driving guide system that calculates a disturbance degree with respect to safe driving in a driver.

In another aspect of the present disclosure, a driving guide system comprises: a sensor that acquires data on a factor that hinders safe driving of a driver; a disturbance degree calculation unit that calculates a disturbance degree indicating a degree of disturbance to the driver's safe driving based on the factor hindering the safe driving of the driver; a tuning execution unit that sets a threshold for level classification of the disturbance degree; a guide content determination unit that, depending on the level, determines guide contents that improve vehicle safety; and a guide content implementation unit that implements the guide contents determined by the guide content determination unit.

Hereinafter, embodiments will be described with reference to the drawings. In the following description, like elements already described are designated by like reference sings, and their description will be omitted. Further, in the following description, a system for calculating a disturbance degree is referred to as a disturbance degree calculation system 1, and a system for determining guide contents according to the calculated disturbance degree and performing guide is referred to as a driving guide system 2. The driving guide system 2 includes the disturbance degree calculation system 1.

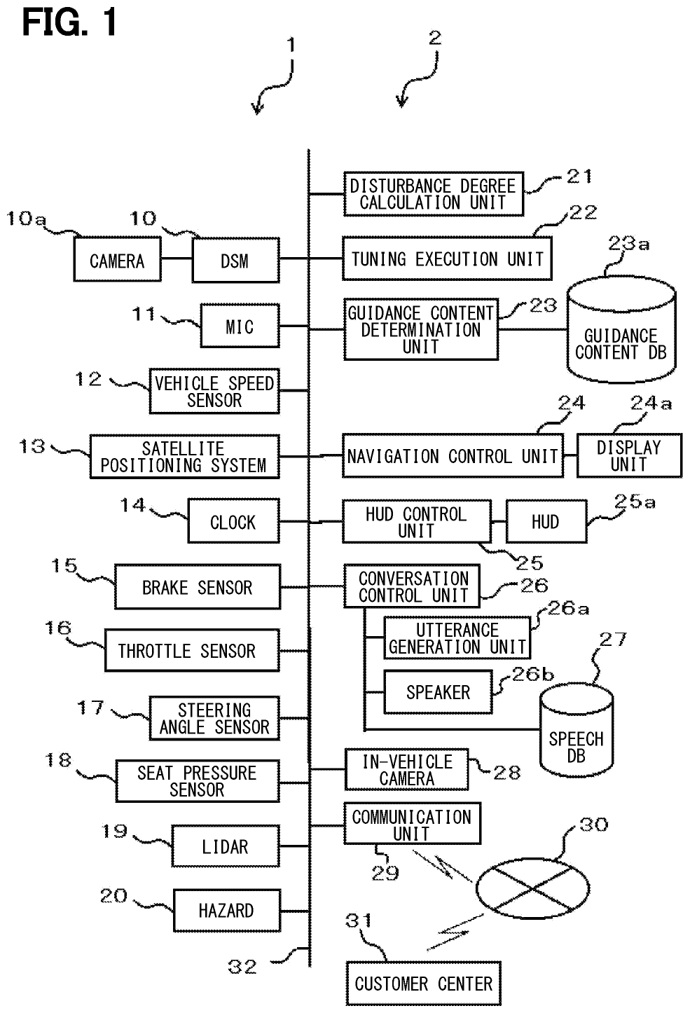

FIG. 1 illustrates a block diagram of a schematic configuration of the driving guide system 2 including the disturbance degree calculation system 1 according to an embodiment. As shown in FIG. 1, the driving guide system 2 includes various sensors and the like, including a driver status monitor (DSM) 10, a microphone 11, a vehicle speed sensor 12, a satellite positioning system 13, a clock 14, a brake sensor 15, a throttle sensor 16, a steering angle sensor 17, and a seat pressure sensor 18, and a LIDAR (Light Detection and Ranging, Laser Imaging Detection and Ranging) 19.

Further, the driving guide system 2 includes control units, an utterance generation unit 26a, a speaker 26b, an in-vehicle camera 28, a communication unit 29, and a hazard lamp 20, wherein the control units include a disturbance degree calculation unit 21, a tuning execution unit 22, a guide content determination unit 23, a navigation control unit 24, a HUD (Head-Up Display) control unit 25, and a conversation control unit 26. As the speaker 26b, a speaker for audio equipment provided in the vehicle may be utilized. These are communicably connected by a communication line 32. The communication line 32 is, for example, an in-vehicle LAN, a CAN, or the like. Further, the driving guide system 2 includes a hazard lamp 20 for notifying surrounding vehicles of an abnormality.

The DSM 10 images the driver's face with the camera 10a and detects the driver status by image analysis. The DSM10 is a device that can detect a driver's failure to pay attention to the road, drowsiness, sleeping, inappropriate driving posture, etc. while driving. The microphone 11 functions as, for example, a voice sensor that detects voice, etc. inside the vehicle. The voice data acquired by the microphone 11 is transmitted to and analyzed by the disturbance degree calculation unit 21 and the conversation control unit 26, and the content thereof is recognized.

The vehicle speed sensor 12 functions as a sensor for measuring the speed of the vehicle. The satellite positioning system 13 functions as a sensor that detects the position of the vehicle on the map and the time of day. Examples of the satellite positioning system 13 include a global satellite system and a regional satellite system. The global satellite systems include GPS, Galileo, GLONASS, etc., and regional satellite systems include MICHIBIKI.

The clock 14 outputs the time of day. The brake sensor 15 functions as a sensor that detects oil pressure of a brake master cylinder of the vehicle and thereby measures a force of the driver's pressing down of a brake. The throttle sensor 16 functions as a sensor that measures an opening degree of an accelerator (throttle). The steering angle sensor 17 functions as a sensor that measures a steering angle of a steering wheel. The seat pressure sensor 18 functions as a sensor that measures the pressure on a seat surface of each seat in the vehicle. The LIDAR 19 functions as a sensor that measures a scattered light as a result of laser irradiation and measures a distance to an object at a long distance. The in-vehicle camera 28 functions as a sensor for capturing a situation inside the vehicle. Sensor information acquired by these sensors is transmitted to the disturbance degree calculation unit 21.

Each of the disturbance degree calculation unit 21, the tuning execution unit 22, the guide content determination unit 23, the navigation control unit 24, the HUD control unit 25, and the conversation control unit 26 includes, as its main component, a microcomputer which includes a CPU, a DRAM, a SRAM, a ROM, an I/O, etc. Functions of each of the disturbance degree calculation unit 21, the tuning execution unit 22, the guide content determination unit 23, the navigation control unit 24, the HUD control unit 25, and the conversation control unit 26 are implemented by, for example, executing a program stored in the ROM.

These disturbance degree calculation unit 21, tuning execution unit 22, guide content determination unit 23, navigation control unit 24, HUD control unit 25, conversation control unit 26, etc. function as control units. These may be configured as an integrally configured control unit.

The disturbance degree calculation unit 21 calculates a disturbance degree based on the sensor information transmitted from the various sensors. The calculated disturbance degree is transmitted to the tuning execution unit 22 and the guide content determination unit 23. The tuning execution unit 22 performs level classification of the disturbance degree by using a threshold. Depending on the level of the disturbance degree, the guide content determination unit 23 determines the guide contents that improve the safety of the vehicle. The guide content database 23a stores thereon the guide contents, and the guide content determination unit 23 reads and determines the guide contents according to the disturbance degree. The calculation of the disturbance degree will be described later.

The navigation control unit 24, the HUD control unit 25, and the conversation control unit 26 execute a guide process according to the guide contents determined by the guide content determination unit 23. The HUD control unit 25 projects information into the driver's field of view. The navigation control unit 24 controls a navigation system that executes vehicle route guidance mainly. The navigation control unit 24 causes the display unit 24a and the HUD control unit 25 causes the HUD 25 to display the guide contents generated by the guide content determination unit 23.

The speaker 26b functions as a speech generation unit that outputs a speech generated by the utterance generation unit 26a according to utterance contents, the utterance contents being generated by the conversation control unit 26 according to the guide contents determined by the guide content determination unit 23. The speech database 27 stores thereon speech data used by the utterance generation unit 26a. The conversation control unit 26 controls conversation with the driver or the occupant via the utterance generation unit 26a, the speaker 26b, and the microphone 11.

The in-vehicle camera 28 acquires a vehicle-inside image, and the image data is transmitted to and analyzed by the disturbance degree calculation unit 21 and the guide content determination unit 23. For example, recognized is: how many occupants are seated on which seats in the vehicle; into which place a thing fell into in cases where the thing placed on the rear seat, the front passenger seat or the like fell; and the like.

The communication unit 29 is connected to a customer center 31 by wireless communication via wireless communication network 30, and transmits and receives various data to and from the customer center 31. The communication unit 29 may be configured as an independent communication unit, or, a communication unit included in, for example, the DSM 10 may be utilized.

(On Disturbance Degree)

The disturbance degree calculation system 1 in the present embodiment estimates the disturbance degree with respect to the safe driving of the driver, from the driving condition of the driver, the situation inside the vehicle, and/or the surrounding situation. The disturbance degree is calculated by the disturbance degree calculation unit 21.

The disturbance degree in the embodiment is defined as a degree of influence, on the driver, of a factor that hinders safe driving from departure from a departure point to arrival at a destination. This disturbance degree also takes into account an influence of a driver's mental change on the safe driving. The factors that hinder safe driving of the driver include at least one of: vehicle type; vehicle speed and acceleration; vehicle position; time; driver condition; passenger condition; or a situation inside the vehicle.

(Disturbance Degree Calculation Method)

The driving condition of the driver, the situation inside the vehicle and the surrounding situation are recognized using: the driver status detected by the DSM 10; the voice inside the vehicle detected by the microphone 11; the vehicle speed and acceleration detected by the vehicle speed sensor 12; the position information of the vehicle detected by the satellite positioning system 13; the current time of day acquired from the clock 14; vehicle operation information detected by the brake sensor 15, the throttle sensor 16 and the steering angle sensor 17; the number of passengers and/or seating position detected by the seat pressure sensor 18; the vehicle inside situation acquired by the in-vehicle camera 28; and/or the like. The voice data such as conversation, etc. inside the vehicle acquired by the microphone 11 is transmitted to and analyzed by the disturbance degree calculation unit 21 and the conversation control unit 26, and the conversation contents and the utterance contents are recognized.

The disturbance degree is calculated by calculating a logistic regression expression using the information of these kinds as an explanatory variable and classifying the calculated probability value <0-1> according to range of a response variable. The logistic regression expression will be illustrated below.

$$\begin{matrix}( Expression 1 ) & \\ y = \frac{1}{1 + {e}^{- ( {a}_{1} \cdot {x}_{1} + {a}_{2} \cdot {x}_{2} + {a}_{0} )}} & ( 1 )\end{matrix}$$

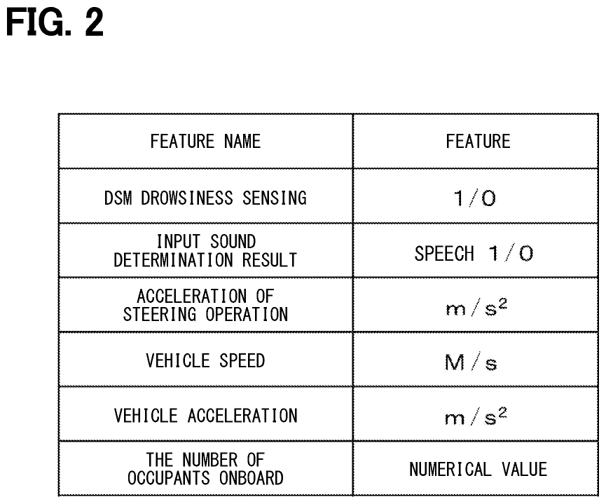

In expression (1), y is the response variable, x is the explanatory variable, a1 and a2 are regression coefficients, a0 is a constant term, and e is the base of the natural logarithm. Analysis using at the logistic regression expression is called logistic regression analysis, and reveals a degree of contribution, to the response variable, of the explanatory variable used in the expression and the probability value calculation. In the embodiment, the explanatory variable is the feature shown in FIG. 2, and the response variable is the disturbance degree. In the embodiment, the disturbance degree is calculated with the expression (1).

The driving guide system 2 makes an announcement to the occupant and/or surrounding vehicle by a speech agent according to the level of the disturbance degree. The speech agent is implemented by executing a program stored in the ROM in the conversation control unit 26. Without using an image character, the speech agent provides a guide on safe operation of the vehicle described in detail below by interacting with the driver by speech when guiding the driver is necessary.

In the situations like the followings, the driving guide system 2 performs, for example, guiding the driver, and alerting the driver, the occupant, and the person outside the vehicle according to the calculated disturbance degree.

Situation 1: The driver is failing to concentrate on driving due to an accident inside the vehicle while driving.

Situation 2: The passenger and/or surrounding vehicle are failing to notice the driver's abnormality

In the embodiment, the influence on safe driving due to the driver's mental change as in Situation 1 is expressed by a value of the disturbance degree. Specifically, the disturbance degree with respect to safe driving is calculated using the information obtained from the inside of the vehicle. The calculation of the disturbance degree utilizes information obtained from the inside of the vehicle (see FIG. 2).

The driving guide system 2 according to the embodiment obtains the disturbance degree by evaluating and ranking the accident inside the vehicle based on a variety of acquired information in an integrated manner, and utilizing a highly versatile probability value (response variable) calculated using the logistic regression equation, which is one of machine learnings.

(Specific Example of Disturbance Degree Calculation)

Next, the calculation of the disturbance degree will be described. The disturbance degree is calculated utilizing, for example, the features shown in FIG. 2, specifically, utilizing: drowsiness detection information acquired by the DSM 10; input sound determination result by analysis of sound acquired by the microphone 11; acceleration of steering wheel operation given by the steering angle sensor 17; vehicle speed and acceleration given by integrated sensing with the vehicle speed sensor 12, the satellite positioning system 13, the brake sensor 15, and the throttle sensor 16; the number of occupants onboard acquired with the seat pressure sensor 18 and the like; and/or the like. It may be calculated utilizing vehicle-inside situation information acquired by the in-vehicle camera 28, the surrounding information obtained with the satellite positioning system 13, the LIDAR 19, etc. It is noted that “I/O” in FIG. 2 corresponds to “present/absent”.

The disturbance degree is a value from 0 to 1, that is, a probability value calculated with a logistic regression expression using the above features, that is, explanatory variables. The coefficient of the logistic regression expression is calculated using learning data that is acquired in advance as sample information. The output of the logistic regression analysis is a probability value, and the contribution of each feature value to the disturbance degree is also calculated. The probability value is easy to handle when making a guide determination using the disturbance degree. In addition, at the time of learning, the degree of contribution is useful for selecting, from various features, a feature that is effectual for estimating the disturbance degree.

In the embodiment, the disturbance degree is classified into the following four levels according to the degree of influence on the driver.

The disturbance degree: degree of disturbance

0: No disturbance

1: concerned while driving

2: Hinder the driving

3: unable to drive

The level 0 of the disturbance degree means that there is no influence on the driving of the driver and there is no hindrance to the continuation of safe driving. The level 1 assumes that, for example, while driving alone, a thing placed on a rear seat falls onto a foot seat. In this case, there is no direct influence on the safety of the driver, that is, it does not directly interfere with driving. However, it hinders the driver's concentrating in that he/she is concerned with what happened to the dropped thing, which is therefore a factor that hinders safe driving. It does not directly influence the driver, but it corresponds to a situation that adversely influences the driver's mental.

The Level 2 corresponds to a situation where, although the driver himself is able to drive, there is a possible direct interfere with the driver's driving, such as when a thing falls into near the driver's foot. The level 3 corresponds to a situation in which it is inappropriate to continue driving because there is a critical problem in the driver's operation itself, for example, the driver becomes drowsy.

(Setting of Threshold for Level Classification of Disturbance Degree)

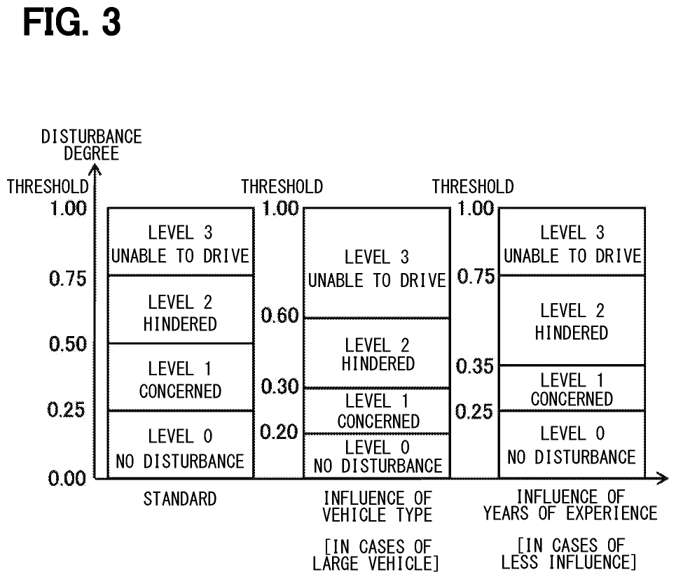

The setting of the threshold for this tuning will be described with reference to FIG. 3. The vertical axis is the value of the disturbance degree. Here, it is assumed that the default threshold setting is that shown as the “standard” in FIG. 3. The standard threshold setting is for such a level classification that at equal intervals of 0.25, the disturbance degree is classified and the interval from the level 0 to the level 1 is 0.25.

Next, the concept will be described for setting the “influence of vehicle type” taking into account the influence of vehicle type. The influence of vehicle type affects the range of the level 3 of the disturbance degree “unable to drive”. An occurrence of an accident involving a truck or bus highly likely leads to a serious accident due to the weight of the vehicle. Also, in the case of highway buses and transport trucks, there is often only one driver, so if it is dangerous, it should promptly notify the surrounding vehicles and customer center 31 (for example, an operation monitoring center of a transportation company). Therefore, as shown in “Influence of vehicle type” in FIG. 3, the range of the level 3 “unable to drive” is set wider than that in “Standard”. Along with this, the thresholds are set so as to narrow the ranges of the level 0 and the level 1.

Next, the concept will be explained for setting the “influence of years of experience” taking into account driving experience. The influence of driving experience affects the range of the level 1 “concerned” and the range of the level 2 “hindered”. If one is not well experienced in driving, even a slight disturbance may hinder the driving. Therefore, the range of the level 2 “hindered” is expanded as shown in “Influence of driving experience” in FIG. 3. Along with this, the range of level 1 “concerned” is narrowed.

On the other hand, if one has a long driving experience, a slight disturbance alone may not affect the driver's mental changes, the setting may be made so as to narrow the range of the level 1 “concerned” and expand the range of the level 0 “no disturbance”.

(Disturbance Degree Calculation Flow)

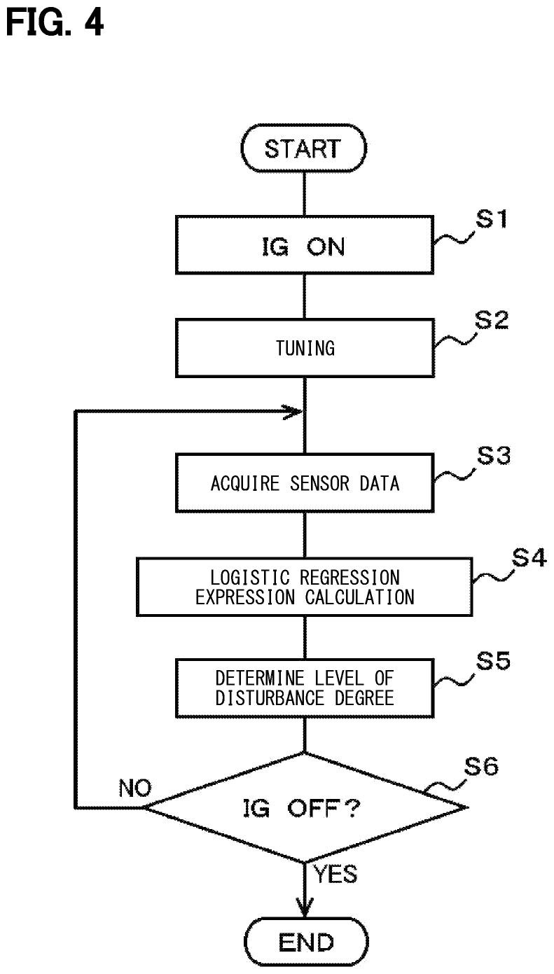

Next, a calculation flow of the disturbance degree in the disturbance degree calculation system 1 will be described with reference to FIG. 4. First, the disturbance degree calculation system 1 is started by turning on the ignition of the vehicle (IG ON), and the display unit 24a of the navigation control unit 24 is placed in an input standby state (S1).

Next, the tuning of the disturbance degree according to the user is executed (S2). The disturbance degree tuning may be performed, for example, by selecting a selection item displayed on the display unit 24a. The selection items are set in advance by the manufacturer or set in advance by the user. Further, as described above, the tuning may be performed by calling the threshold of the disturbance degree associated with the face data in advance by recognizing the face data with the in-vehicle camera 28.

After that, acquisition of various sensor data is started (S3). The disturbance degree calculation system 1 calculates a logistic regression expression based on the sensor data (S4), and determines the disturbance degree based on the set tuning of the disturbance degree (S5). After that, the sensor data is continuously acquired until the ignition is turned off (S6).

(Guide Contents)

Next, the guide contents depending on the level of disturbance degree will be described. The guide contents are determined by the guide content determination unit 23 based on the disturbance degree and the outside vehicle information. The disturbance degree is calculated by the disturbance degree calculation unit 21. The outside vehicle information is detected by the LIDAR 19. The guide content determination unit 23 controls the conversation control unit 26 and the utterance generation unit 26a according to the determined guide contents, executes a speech agent, and performs guide for the occupant and/or surrounding vehicle.

The guide contents include any of: providing the guide for the driver; the providing the guide for the passenger; and the setting of a recommended stop location to the navigation system as a next destination. For example, when the disturbance degree is level 2, the guide contents are such that: the driver and/or passenger is warned by the speech agent controlled by the conversation control unit 26; the connection to the customer center 31 via the communication unit 29 is made and a warning to the driver is issued from the operator of the customer center 31; and/or the like. Further, the navigation system may be equipped with a warning alarm function to warn the driver.

When the disturbance degree is level 1, the guide is performed such that: the speech agent controlled by the conversation control unit 26 speaks to the driver, such as “Don't worry, concentrate on driving”, and/or urge the passenger to solve what the driver is concerned about, and/or the like.

In addition to the disturbance degree, the outside vehicle information is further utilized to determine the guide contents. This is because the determination on safe driving depends on the surrounding environment. The vehicle outside information is recognized from the surrounding information detected by LIDAR 19 and the surrounding information grasped from the map information and the position information with the satellite positioning system 13.

The LIDAR 19 makes it is possible to analyze the distance to the target and the nature of the target, and thus, it is possible to grasp information such as the surrounding road condition and whether or not there is a different vehicle, people and/or the like in the surroundings. The road condition, the feature, etc. stored as the map data is recognizable from the map information and the position information by the satellite positioning system 13. In addition, from the map information and the position information by the satellite positioning system 13, it is possible to acquire information such as whether the vehicle is currently traveling on an expressway or a local road.

For example, when the level of the disturbance degree is high, it is necessary to change the guide contents depending on whether the vehicle is traveling on a local road or an expressway. In cases of local roads, it may be possible to guide the driver to stop a vehicle in a stoppable or parkable zone immediately, but in cases of expressways, it may be impossible stop the vehicle on the side of the road or on the shoulder, so that the guide is performed to stop the vehicle at a nearby service area or parking area, to get off the expressway, and/or the like.

The information acquired by the seat pressure sensor 18 is also utilized to determine the guide contents. This is because when there is a passenger other than the driver, the driving guide system 2 can guide not only the driver but also the passenger.

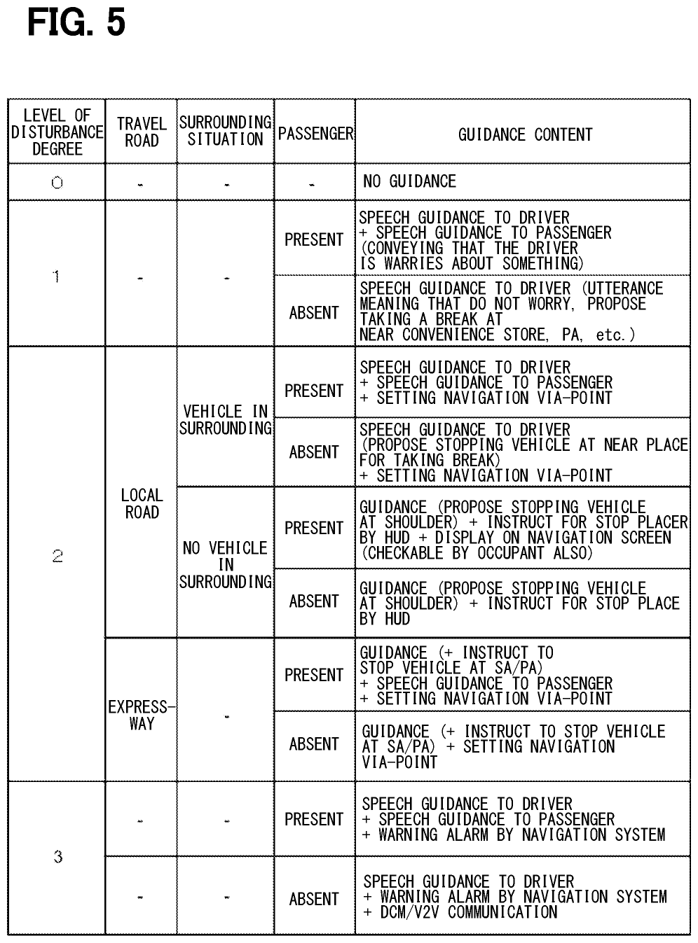

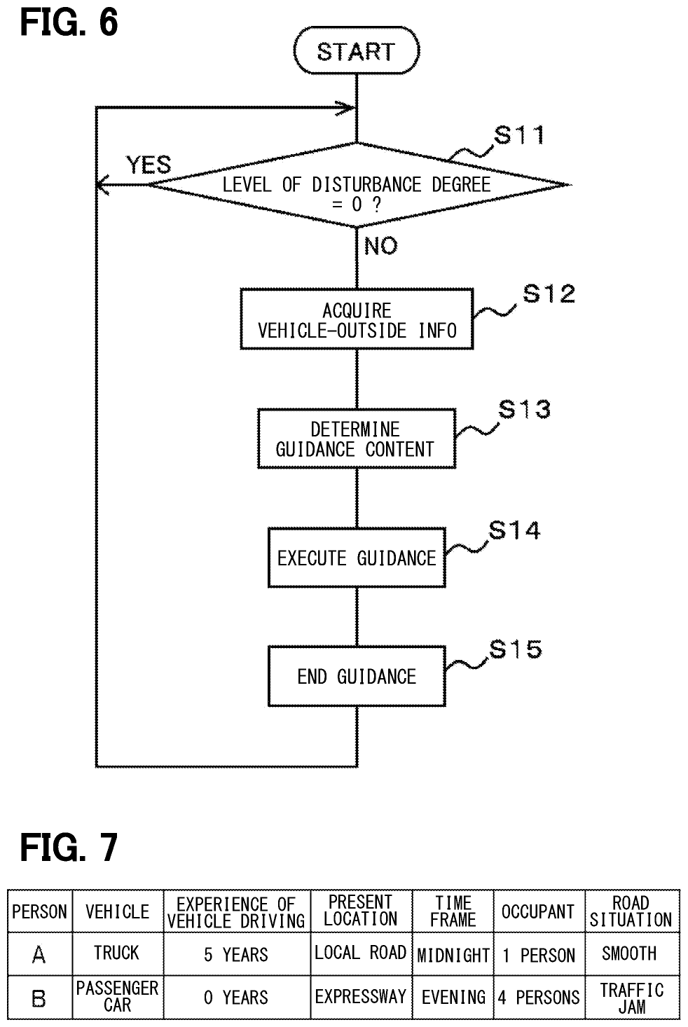

FIG. 5 shows an example of guide contents depending on the level of disturbance degree, the traveling road, the surrounding condition, and the presence or absence of passenger. Further, FIG. 6 shows a flowchart of guide implementation by the guide content determination unit 23. First, the guide content determination unit 23 determines whether or not the disturbance degree calculated by the disturbance degree calculation unit 21 is the level 0 (S11). When the level of the disturbance degree is not the level 0, that is, when the level of the disturbance degree is the level 1, 2, or 3, the vehicle outside information is acquired from the LIDAR 19 and the satellite positioning system 13 (S12).

Next, the guide content determination unit 23 determines the guide contents based on the level of the disturbance degree and the outside information (S13). Next, the driving guide system 2 guides the driver and/or the passenger based on the determined guide contents (S14). The guide includes the guide by display on the display unit 24a by the navigation control unit 24, the guide by display on the HUD 25a by the HUD control unit 25, and the guide by utterance by the speech agent controlled by the conversation control unit 26.

The guide may be provided by the operator of the customer center 31 via the communication unit 29 and the wireless communication network 30. After that, when the guide is completed (S15), the driving guide system 2 ends the guide and returns to the determination of the disturbance degree (S11).

(Specific Tuning Example)

Next, the tuning of the level classification of the disturbance degree according to given thresholds will be described with reference to FIG. 7. The tuning execution unit 22 executes tuning of the disturbance degree. The tuning execution unit 22 sets thresholds for classification of the disturbance degree into levels.

For example, as shown in FIG. 7, it is assumed that a person A who usually drives a passenger car rents a truck for house moving. In this case, the person A has 0 years of driving experience of that vehicle, and the vehicle type is a truck. These parameters tell that this person will drive the vehicle that he has never driven yet, and therefore, it is preferable to determine the level 2 (hindering the driving) in situations where the level 1 (concerned while driving) is determined if ordinary.

In view of this, in the level classification of the calculated disturbance degree by threshold, the tuning is performed to set the threshold for the level classification so that the disturbance levels 0 to 3 are appropriately determined. In this tuning, for example, a driver who drives a rental car or a large bus sets the threshold of the disturbance degree by making the setting with his/her smartphone or navigation module before driving.

In the cases of a private car for example, the driver's face data taken by the in-vehicle camera 28 and the threshold for level classification of the disturbance degree are linked to each other and registered in advance so that the setting is made by reading the threshold linked to the driver's face data authentication that is acquired by the in-vehicle camera 28 when the driver gets on the vehicle.

Next, description will be given of a case where the person B in FIG. 7 gets on as a driver. When the B turns on the ignition of the vehicle (S1), the disturbance degree calculation system 1 is activated, and the display unit 24a of the navigation control unit 24 is activated. In addition, the in-vehicle camera 28 executes face recognition of the B. In this case, it is assumed that there is the face image of B registered in the disturbance degree calculation system 1.

The face image acquired by the in-vehicle camera 28 is collated with the database, and the disturbance degree calculation system 1 detects a match with the pre-registered face of the B. After that, the tuning is performed by calling the threshold of the disturbance degree linked to the face data of B (S2).

(Operation Example)

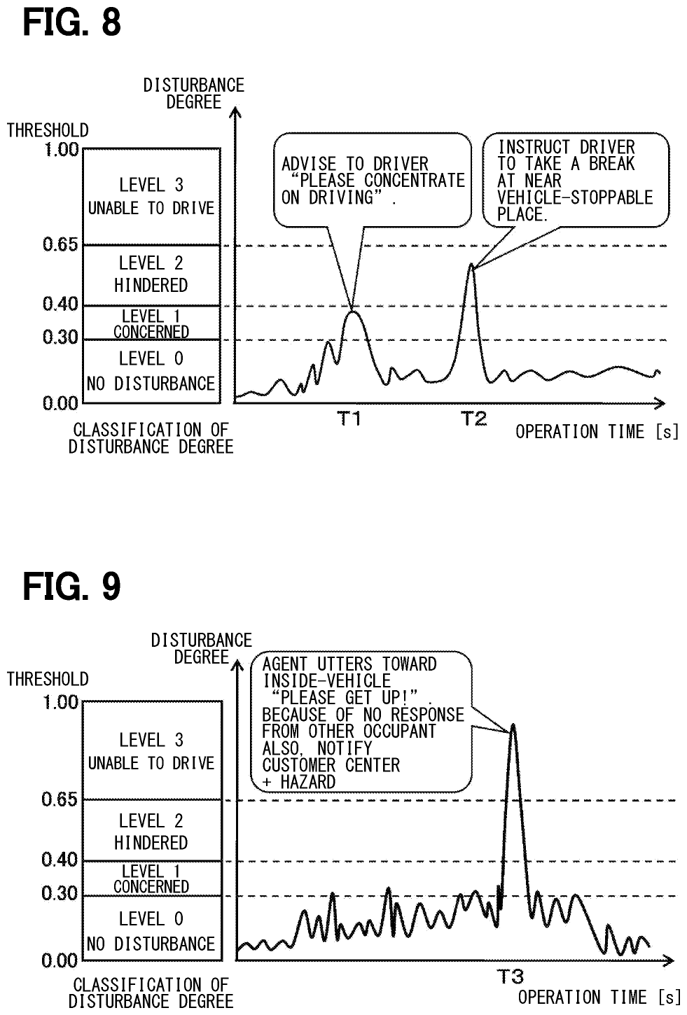

A specific operation example of the disturbance degree calculation system 1 and the driving guide system 2 will be described with reference to FIGS. 7 and 8. First, description will be given of a case where the person A in FIG. 7 gets on as a driver. When the A turns on the ignition of the vehicle (S1), the disturbance degree calculation system 1 is activated, and the display unit 24a of the navigation control unit 24 is activated. In this case, there is no face image of A registered in the disturbance degree calculation system 1.

The in-vehicle camera 28 tries to recognize the face of A, but the face recognition is unsuccessful because there is no face image of A registered in the disturbance calculation system 1, and the tuning execution unit 22 requests the driver to tune the level classification of the disturbance degree. The tuning is performed, for example, by making a selection from options prepared in advance to input the vehicle type and the driving experience of that vehicle. By this operation, for example, as shown in FIG. 8, the level classification of the disturbance degree is tuned by setting the threshold according to the selected item (S2).

Next, when A starts the driving operation, the sensor data is acquired (S3), and the calculation of the logistic regression expression is executed (S4), wherein the sensor data is transmitted from the DSM 10 attached to the vehicle, the microphone 11, the vehicle speed sensor 12, the satellite positioning system 13, the clock 14, the brake sensor 15, the throttle sensor 16, the steering angle sensor 17, and the seat pressure sensor 18, the LIDAR 19, the in-vehicle camera 28, etc.

Here, for example, at the time T1 in FIG. 8, it is assumed that there is a change in the driver's line of sight and brake control due to the sound of something moving inside the truck. The influence on A such as the movement of an object in the vehicle is detected by analyzing the face image information of A given by the DSM 10, the audio information in the vehicle acquired by the microphone 11, and the in-vehicle video information acquired by the in-vehicle camera 28.

After that, every time the A operates a steering wheel (not shown) in the truck, the luggage makes a sound of moving left and right, and therefore, the regression coefficient of the logistic regression expression (1) for the feature of the input sound determination result (see FIG. 2) is increased and the disturbance degree gradually increases. When the disturbance degree exceeds the threshold of 0.30, the guide content determination unit 23 determines the level 1 of the disturbance degree (S5), and determines the guide contents corresponding to the level 1 of the disturbance degree. Corresponding to the determined guide contents, the speech agent controlled by the conversation control unit 26 speaks to the A, for example, “Please concentrate on driving. If you have any concerns, please stop the vehicle and check it out.” and/or the like.

Such utterance information is stored in the speech database 27. In response to the utterance, the A stops the vehicle and check whether there is no problem with the luggage. In the subsequent driving situation, the factor that had raised the disturbance degree disappears, so that the disturbance degree can be lowered.

After that, the driving is smooth for a while, but at time T2, DSM 10 detects the A's yawning. Since yawning is closely related to drowsiness, the regression coefficient of the logistic regression expression (1) with respect to the feature of DSM drowsiness detection (see FIG. 2) is increased, and the disturbance degree gradually increases. When the disturbance degree increases and exceeds the threshold of 0.45, the guide content determining unit 23 determines the level 2 of the disturbance degree (S5), and determines the guide contents corresponding to the disturbance degree 2.

Corresponding to the determined guide contents, the speech agent controlled by the conversation control unit 26 speaks to the A, for example, “Are you okay?” or the like, and then “Would you like to stop temporarily at XX ahead?” or the like, and display the stop location with the HUD 25a. Similar contents may be displayed with the display unit 24a of the navigation control unit 24 or the HUD 25a. In this case, the navigation control unit 24, the display unit 24a, the HUD control unit 25, the HUD 25a, the conversation control unit 26, the utterance generation unit 26a, and the speaker 26b function as a guide content implementation unit.

The A stops the vehicle following the guide by the speech agent. After the vehicle is stopped, the speech agent utters “Let's take a break at XX” and presents a break candidate location with the display unit 24a of the navigation control unit 24. The driver sets the location as a via-point or a target point and resumes the driving operation.

If there is a passenger and the passenger is awake, a guide such as “The driver seems sleepy! Please have a conversation!” or the like, or “Take a break at a nearby convenience store” is uttered and the location information of the convenience store is displayed with the display unit 24a and/or HUD 25a.

If the vehicle is equipped with an autonomous driving system, control may be performed such as controlling the vehicle driving, while ensuring safety of the vehicle and surroundings, to stop the vehicle in the shoulder, a parking area of the service area or the convenience store, etc. Further, if the disturbance degree is high, the notification may be given to the surrounding vehicles, the customer center 31, and the like.

Next, description will be given of a case where the person B in FIG. 7 gets on as a driver. The ignition of the vehicle is turned by the B (S1) and the tuning is performed by calling the threshold of the disturbance degree linked to the face data of the B by the face recognition of the B with the in-vehicle camera 28. The B is able to concentrate on driving halfway to the destination, but as shown in FIG. 9, at time T3, the B become drowsy after having long driving on the expressway and having got stuck in a traffic jam. Accordingly, the disturbance degree is increased to the level 3 due to the acceleration of the steering wheel operation (see FIG. 2) and the drowsiness detection by the DSM10.

In this case, the disturbance degree calculation system 1 utters “Please get up!” to the B and the passenger via the speech agent controlled by the conversation control unit 26. Since dozing driving is highly dangerous, a loud sound is reproduced to awake the driver and passenger at the first place. If neither the driver nor the passenger responds, the customer center 31 or the like is notified via the communication unit 29, and the operator or the like stationed at the customer center 31 speaks to the occupant in the vehicle via the in-vehicle speaker 26b. As a result, the driver B and the passenger are alerted and the occurrence of an accident is prevented. In such a case, the disturbance degree calculation system 1 flashes the hazard 20 of the vehicle to notify the surroundings of the danger. Further, in the case of a vehicle equipped with a vehicle-to-vehicle communication system, the vehicle-to-vehicle communication system may be used to notify the surrounding vehicle of danger.

Also, the guide contents by the guide content determination unit 23 are set to minimize the driver's judgment, thereby causing the driver to concentrate on driving. For example, when the disturbance degree increases due to the drowsiness of the driver, the guide content determination unit 23 is configured to dare to present only one stop place instead of presenting a plurality of stop places. In this way, the safety of vehicle operation is ensured by reducing the driver's judgment.

According to the driving guide system 2 of the embodiment, the following effects are obtained. The disturbance degree calculated by the disturbance degree calculation system 1 is calculated with machine learning, and thus, the disturbance degree is provided as a probability value (that is, a response variable). Further, the contribution of each feature (that is, the explanatory variable) is provided as its coefficient. As a result, it is possible to easily set the threshold, that is, tune the level classification according to the threshold of the disturbance degree. Further, it is possible to provide a driving guide system 2 that classifies the calculated disturbance degree into levels according to a threshold and determines the guide for the driver according to the level.

Although the present disclosure has been described in accordance with the examples, it is to be understood that the disclosure is not limited to such examples or structures. The present disclosure also encompasses various modifications and variations within an equivalent range. Furthermore, various combinations and modes, and other combination and modes including only one, more or less element, fall within the spirit and scope of the present disclosure.

The control units and methods described in the present disclosure may be implemented by a special purpose computer provided by configuring a memory and a processor programmed to execute one or more functions embodied by a computer program. Alternatively, the control units and methods described in the present disclosure may be implemented by a special purpose computer provided by configuring a processor with one or more dedicated hardware logic circuits. Alternatively, the control units and methods described in the present disclosure may be implemented by one or more special purpose computers configured by combining a memory and a processor programmed to execute one or more functions with one or more dedicated hardware logic circuits. The computer program may also be stored in a computer readable non-transitory tangible storage medium as instructions to be executed by a computer.

In the embodiment, the disturbance degree is calculated by using a logistic regression expression as an example of machine learning, but the disturbance degree may be calculated by using such methods as a support vector machine, deep learning, etc.

What is claimed is:

1. A driving guide system comprising:
a sensor that acquires data on a factor that hinders safe driving of a driver;
a disturbance degree calculation unit that calculates a disturbance degree indicating a degree of disturbance to the driver's safe driving based on the factor hindering the safe driving of the driver;
a tuning execution unit that sets a threshold for level classification of the disturbance degree;
a guide content determination unit that, depending on the level, determines guide contents that improve vehicle safety; and
a guide content implementation unit that implements the guide contents determined by the guide content determination unit,
wherein:
the guide contents determined by the conversation control unit include any of: providing guide to the driver; providing guide to a passenger; and setting a vehicle stop recommendation point as a next destination to a vehicle navigation system;
the level classification of the disturbance degree is performed with a threshold that is set according to degree of disturbance to driver's safe driving; and
which guide contents is set depends on the level classification.

2. The driving guide system according to claim 1, wherein:
the disturbance degree is calculated with machine learning.

3. The driving guide system according to claim 2, wherein:
the disturbance degree is calculated with a logistic regression expression.

4. The driving guide system according to claim 3, wherein:
a response variable is the disturbance degree and an explanatory variable is the factor hindering the safe driving of the driver.

5. The driving guide system according to claim 1, wherein:
the factor hindering the safe driving of the driver includes at least one of: vehicle type; vehicle speed and acceleration; vehicle position; time; driver condition; passenger condition; or a situation inside the vehicle.

6. A driving guide system comprising:
a sensors that acquires data on a factor that hinders safe driving of a driver;
one or more computers that:
calculates a disturbance degree indicating a degree of disturbance to the driver's safe driving based on the factor hindering the safe driving of the driver;
sets a threshold for level classification of the disturbance degree;
depending on the level, determines guide contents that improve vehicle safety; and
implements the determined guide contents with a display and/or a speaker,
wherein:
the determined guide contents include any of: providing guide to the driver;
providing guide to a passenger; and setting a vehicle stop recommendation point as a next destination to a vehicle navigation system;
the level classification of the disturbance degree is performed with a threshold that is set according to degree of disturbance to driver's safe driving; and
which guide contents is set depends on the level classification.
